(19) United States
(12) Patent Application Publication
(10) Pub. No.: US 2016/0005007 A1
(43) Pub. Date: Jan. 7, 2016

(54) METHODS AND SYSTEMS FOR USING SCANABLE CODES TO OBTAIN MAINTENANCE AND REMINDER SERVICES

(71) Applicant: Flashback Survey, Inc., Chapel Hill, NC (US)

(72) Inventor: Peter J. Marsico, Chapel Hill, NC (US)

(21) Appl. No.: 14/789,594

(22) Filed: Jul. 1, 2015

Related U.S. Application Data
(60) Provisional application No. 62/021,062, filed on Jul. 4, 2014.
(60) Provisional application No. 62/024,867, filed on Jul. 15, 2014.
(60) Provisional application No. 62/100,498, filed on Jan. 7, 2015.

(51) Int. Cl. G06Q 10/00

(52) U.S. Cl. CPC G06Q 10/20

(57) ABSTRACT

Disclosed are methods, systems and computer program products for facilitating scan-triggered PAMR instruction and reminder services to a user using a scanable information encoded graphic image, such as a bar code or a quick response (QR) code. A mobile communication device such as a smartphone, tablet computer or other mobile computer may include a scan client module for scanning and communicating scan-triggered service code information to a scan-triggered application server. The scan-enabled client module communicates extracted PAMR instruction set identifier information to an associated scan-triggered PAMR instruction and reminder service server application, which is adapted to resolve and deliver chronologically ordered PAMR instruction step information to the scanning user, as well as providing reminder notification services and collecting instruction step compliance data.

### PRIORITY CLAIM

This application claims the benefit of U.S. Provisional Patent Application Ser. No. 62/021,062, filed on Jul. 4, 2014, U.S. Provisional Patent Application Ser. No. 62/024,867, filed on Jul. 15, 2014, U.S. Provisional Patent Application Ser. No. 62/100,498, filed on Jan. 7, 2015; the disclosures of which are incorporated herein by reference in their entireties.

### TECHNICAL FIELD

The subject matter described herein relates to methods and systems for using a scanable service code to provide product care, maintenance and reminder services to a scanning user.

### BACKGROUND

Manufacturers and retailers of consumer goods currently struggle to engage consumers in product post-purchase settings, as physical goods and the associated packaging do not lend themselves to technologies that can easily facilitate network connected communication. Quick response (QR) codes and other types of scanable code technologies can be scanned by users of mobile communication devices, such as smartphones, tablet computers, notebook computers, and other wearable computing devices, such as computer-integrated eyeglasses, so as to rapidly extract information from appropriately encoded indicia and/or tags with minimal chance of data input error. What is needed is a system and method to enable a scanning user (e.g., consumer) to quickly and easily access product-specific instruction step and reminder information, receive instruction step reminders, signal compliance with these instruction steps, and receive associated instruction step compliance incentives.

### SUMMARY

According to one aspect, the subject matter described herein includes systems and methods for facilitating the association of a product use, maintenance or care instruction set or template with a scanable service scan code. Exemplary product associated maintenance and reminder (PAMR) instruction sets may include plant product care instructions and reminders, air or water filter product cleaning or replacement instructions and reminders, contact lens product cleaning or replacement instructions and reminders, food storage container use instructions and reminders, etc. In one embodiment, a PAMR instruction set or template may include relative date/time offset information for each instruction step (e.g., change/replace contact lenses every 2 weeks, water plant every 3 days, consumer the contents of this storage container within 4 days, etc.). The associated scan code is scanned (e.g., by a user/consumer, etc.) and reference date/time information (e.g., purchase date/time information, most recent replacement date/time information, etc.) is provided. Reference date/time may be manually input or selected by the scanning user, or may be implied from/taken as the date/time associated with the scanning of the scanable PAMR service code. The reference date/time information is bound to the user and is used to resolve the relative date/time offsets in the associated PAMR instruction set or template, such that a chronologically ordered set of PAMR instruction steps is presented to the user. A user may signal compliance for each instruction step, and the compliance information is logged. Compliance incentive rewards may be offered and distributed to a scanning user. A compliance guardian may be associated with a user's PAMR instruction set, such that the compliance guardian is notified (e.g., via text message, email, etc.) if the user does not signal compliance with a required PAMR instruction step. Electronic calendaring event invitations/reminders may be associated with and generated for PAMR instruction steps and transmitted to the user. Text or instant message reminder notification messages may be generated for PAMR instruction steps and transmitted to the user. In cases where an instruction step is optional, a user may be presented with an indicator of the earliest recommended date/time that the instruction step should be performed, or sent a reminder (e.g., text message) at the earliest recommended date/time that the instruction step should be performed.

The subject matter described herein for providing scan-triggered services may be implemented in hardware, software, firmware, or any combination thereof. As such, the terms “function” or “module” as used herein refer to hardware, software, and/or firmware for implementing the feature being described. In one exemplary implementation, the subject matter described herein may be implemented using a computer readable medium having stored thereon computer executable instructions that when executed by the processor of a computer perform steps. Exemplary computer readable media suitable for implementing the subject matter described herein include disk memory devices, programmable logic devices, application specific integrated circuits, and downloadable electrical signals. In addition, a computer readable medium that implements the subject matter described herein may be located on a single device or computing platform distributed across multiple physical devices and/or computing platforms.

### BRIEF DESCRIPTION OF THE DRAWINGS

Embodiments of the subject matter described herein will now be explained with reference to the accompanying drawings of which:

FIG. 1 is a block diagram which illustrates a mobile communication device (e.g., smartphone) that includes a scanable code reader module, such as a quick response (QR) code scanner module and exemplary scan-enabled client module;

FIG. 2 is a block diagram which illustrates an application server that includes an exemplary server application module, which is adapted to facilitate the creation and processing of a scanable PAMR instruction and reminder service code and associated compliance incentive and just in time rewards;

FIG. 3 is a diagram that illustrates several exemplary embodiments and associated product deployments of scan-triggered PAMR instruction and reminder services;

FIG. 4 is a process flow diagram which illustrates exemplary provisioning of a scan-triggered application services platform that is adapted to provide scan-triggered PAMR instruction and reminder services;

FIGS. 5A-5C illustrate exemplary processing and information flows associated with an exemplary embodiment of scan-triggered PAMR instruction and reminder services that involves the use of pre-defined scheduling offset rules;

FIG. 6 illustrates exemplary processing and information flows associated with an exemplary embodiment of scan-triggered PAMR instruction and reminder service that involves the use of user-selectable scheduling offset option tuples;

FIG. 7 illustrates exemplary processing and information flows associated with a subsequent scan of a scan-triggered PAMR instruction and reminder service scan code;

FIG. 8 illustrates exemplary processing and information flows associated with a scan of a scan-triggered PAMR instruction and reminder service scan code that is intended to signal user compliance with an associated PAMR instruction step; and

FIGS. 9-13 illustrate exemplary user and PAMR instruction and reminder service provisioning data associated with embodiments of the present PAMR instruction and reminder service subject matter.

### DETAILED DESCRIPTION

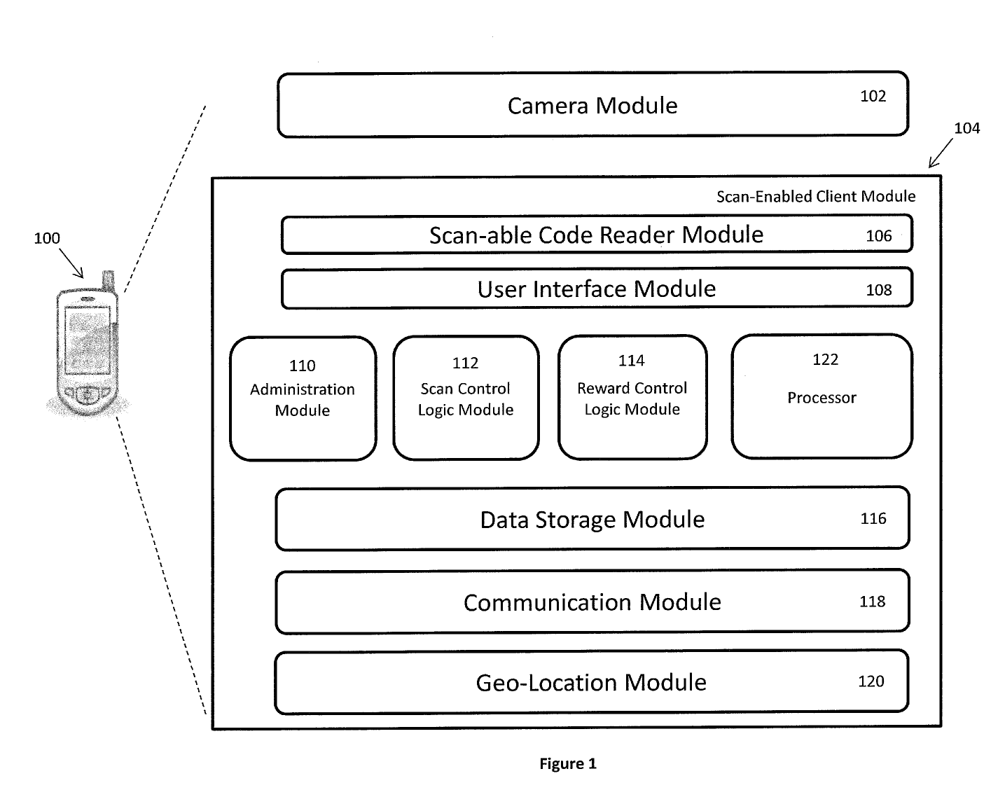

Disclosed are systems and methods for using a scanable code, such as quick response (QR) code, a near field communication (NFC) code, radio frequency identification (RFID) code, or similar optical, magnetic or electrical scanable codes, to provide PAMR related services to a user who scans an associated scan-triggered PAMR service scan code. In a one embodiment, a scan code-based services system of the subject matter described herein includes a scan-enabled client module, which may be implemented in hardware, software, firmware or a combination thereof and which resides on a mobile communication device, such as a smartphone, tablet computer, netbook computer, computer-integrated eyeglasses, computer-integrated wristwatch, wearable electronics or other mobile computing device that is capable of communicating with a network server. The scan-enabled client module may include an executable computer program (e.g., C++, Java, etc.) that is adapted to be downloaded onto the mobile communication device, installed and executed. The scan-enabled client module may also include a web browser that is adapted to access and execute web-based software (e.g., JavaScript, etc.) that provides a least a portion of the necessary scan-enabled client functionality. FIG. 1 is a block diagram that illustrates an exemplary architecture of a smartphone-based scan-enabled client module. Smartphone 100 includes a camera module 102 that is adapted to capture, process and/or store an image in a digital format. Smartphone 100 also includes a scan-enabled client module 104. Scan-enabled client module 104 is comprised of scanable code reader module 106 (e.g., optical QR or bar code reader, NFC or RFID reader, etc.), a user interface module 108, an administration module 110, a scan control logic module 112, a participation reward control logic module 114, a data storage module 116, a communication module 118, geo-location module 120, and processor 122.

Scan-enabled client module 104 is adapted to scan and extract information from a scan-triggered service scan code, which is subsequently provided to a scan-triggered application server that is hosting the PAMR instruction step service. The extracted scan-triggered product associated maintenance and reminder service code information (e.g., ChangeltSquareID, PlantCareSquareID, StoreSafeSquareID, JITSquareID, PAMR_ID, etc.) may comprise information that is representative, for example, of an alphanumeric text string and/or a numeric code, which may include or incorporate a uniform resource locator, network address or other information usable to route a request for PAMR service to a server for processing the request. In one embodiment, the extracted scan-triggered service information may be used to identify a PAMR set or template and to facilitate the providing of scan-triggered compliance incentive rewards based on the scanning of PAMR service scan codes. The decoded PAMR service scan code information is provided to an associated scan-triggered server application module via communication module 118. In an alternate embodiment, scan code reader module 106 is adapted to receive digital image information from camera module 102 and to communicate the digital image information (e.g., JPEG) to an associated server application module via communication module 118 where decoding processing is performed. In one embodiment, information that identifies or can be used to identify a scan-triggered PAMR service user (e.g., user name, user ID, session ID, mobile device identifier, etc.) is also provided to the server application module.

User interface module 108 is adapted to present the mobile device user with a graphical user interface for enabling the user to generally control and operate the functionality of the scan-enabled client module 104. User interface module 108 is adapted to present PAMR instruction step information, as well as a menu structure to the user and enable the user to navigate this menu structure. The menu structure provides a user with access to administrative functions, such as scan triggered service account settings (e.g., username, password, service preferences, personal information, etc.), account log-in. Such administrative functions are controlled within scan-capable or scan-enabled client module 104 via administration module 110. The menu structure may also provide the user with the ability to control the associated smartphone camera. In some embodiments, the ability to access and operate the smartphone camera in the manner required to effectively photograph or scan an optical scan code, such as a QR code, is provided via scan control logic module 112. In one exemplary embodiment, scan-enabled client module 104 may include a native application that is adapted to execute on mobile device 100, and in such a case that native application may include QR scanning/decoding capability or alternatively scan-enabled client module 104 may simply invoke the services of a third-party QR scanner/decoder that is installed in the mobile device. In another exemplary embodiment, a generic third-party QR scanner/decoder may be invoked by the mobile device user to scan and decode a suitably provisioned QR, where decoding of the QR code causes a web browser instance to be launched and directed to or towards a URL associated with the PAMR instruction step service hosting application server. In this case, information that identifies the relevant/necessary scan-triggered PAMR instruction set/template/service information may be passed to the application server via the URL/URL parameters. For example, in one embodiment, information that identifies a specific PAMR instruction step set or template may be explicitly or implicitly communicated to the application server via the URL itself (e.g., the host name and/or path and/or parameter components of the URL can be used by the hosting application server to explicitly or implicitly identify the PAMR instruction and reminder set, template or service).

In an alternate embodiment, for example, all communications between the user's mobile device and the application server may be addressed to a URL which points to a scan-based service provider (e.g., www.PoweredByPostdoc.com), and the information that identifies the particular PAMR instruction step set or template may be communicated to the scan-based service provider's application server via the path and/or query string parameter portions of the URL. In one embodiment, such a URL address associated with the scan-triggered service platform may be encoded or otherwise incorporated into a scan code associated with a scan-triggered service platform, or which requests scan-triggered application service from a scan-triggered service platform. In one embodiment, the URL which points scan-based service provider (e.g., www.PoweredByPostdoc.com), and the information that identifies the scan-triggered service may be encrypted, such that only a particular code scanner, native mobile code scanning application, or mobile web browser with integrated code scanning capability which has access to or is provisioned with the appropriate decryption/de-obfuscation key information can decode and process the scan-triggered service URL information and thereby facilitate the providing of the associated scan-triggered service. As such, a particular scan-triggered service code may be “locked” to all code scanners but the scanner that has access to/is provided with the appropriate decrypt/de-obfuscation key information, thereby providing users with an added measure of security and privacy with respect to accessing the scan-triggered PAMR instruction step services.

In one embodiment, a menu structure provides the user with the ability to access and redeem PAMR instruction compliance incentive rewards. Compliance incentive reward access and redemption functionality is provided by reward control logic module 114. Data storage module 116 is adapted to provide both long term storage of data associated with the scan-enabled client module, as well as short term, cache-type storage of scan client related data. Exemplary uses of the data storage are discussed in more detail in the disclosure that follows.

Communications module 118 is adapted to facilitate the communication of information between scan-enabled client module 104 and an associated server application module. For example, communication module 118 may receive information from scan control logic module 112 that is to be communicated to an associated server application module. Communication module 118 may package the information according to a pre-defined message format and forward the message to a data communications interface associated with the smartphone. Exemplary data communication interfaces may include, but are not limited to, a General Packet Radio Service (GPRS) interface, an Enhanced Data Rates for GSM Evolution (EDGE), High Speed Packet Access (HSPA), WiMax, WiFi, LTE, etc. For example, in one embodiment, when a user scans a service scan code associated with a scan-triggered product associated maintenance instruction and reminder service, communication module 118 is adapted to communicate to an associated server application module information that was encoded in the scanned PAMR service code (e.g., PlantCareSquareID, ChangeltID, JITSquareID, StoreSafeSquareID, etc.), as well as information that can be used to identify the user. Information that can be used to identify the user may include a user identifier (e.g., username, email address, mobile IP address, mobile device identifier, session ID, etc.). It will be appreciated that the communication of such user identifying information to the server module may be triggered upon scanning of the QR code or may be triggered upon startup of software associated with scan-enabled client module 104 (e.g., auto-login, manual login, etc.). As such, the communication of user identifying information and PAMR instruction set or template information obtained from the scanning of a scan code may be accomplished via a single message that is communicated between scan-enabled client module 104 and an associated server module, or this information may be communicated via multiple messages to the application server module. In one embodiment, when a user presents login credentials (e.g., username and password) and is successfully authenticated, a communication channel or session is established between a scan-enabled client module (e.g., a smartphone web browser or native application) and a server application module (e.g., an application residing on a network-based host computer), and all subsequent communications made via the session or channel are associated with the user's login credential/identity information. In this way, a user's identity information may be provided before, during, or even after the scanning of an associated service scanable code (e.g., QR code, NFC code, RFID code, etc.), and thereafter bound to the information derived or obtained from scanning of the code. In another embodiment, the scanning of a scan code by a user triggers the scan-enabled client module 104 to access previously stored login credential information (e.g., user identifying login credential information stored in a file or cookie that is resident on mobile communication device 100. Scan-enabled client module 104 automatically provides the user's login credentials to the application server module, which then associates the information obtained from the scanning of the scan code with the user's scan-triggered PAMR instruction service account. Once the session is established, information obtained and provided to the application server module is automatically associated with the user's account. These same user identity binding techniques may be employed with any of the embodiments of the subject matter described herein.

Geo-location module 120 is adapted to determine geo-location information indicative of the geographic position of mobile communication device 100. Geo-location information determined by module 120 may include Global Positioning System (GPS) coordinate information (e.g., latitude, longitude, elevation). Module 120 may determine this geo-location information and generally facilitate the communication of this information to an associated server application module in conjunction with the communication of scanned graphic icon (e.g., QR code) information, thereby enabling the server application module to identify and store the location at which a QR code was scanned. Alternatively, geo-location or position information may be encoded in the QR code that was scanned, and once scanned the location information may be decoded by geo-location module 120 and passed along to a server application module associated with the scan code-based service system. It is understood that with the addition of scan-enabled client module 104, mobile device 100 becomes a special purpose computing platform that improves the functionality of mobile device 100 by providing direct access to a server application in response to receiving a scanned code from camera module 102. Mobile device 100 with scan-enable client module 104 also improves the technical field of network access to services because such services can be accessed automatically and quickly with a reduced likelihood of data entry errors. Processor 122 is adapted to facilitate the execution of software and firmware associated with the operation of modules 106, 108, 110, 112, 114, 116, 118 and 120, which is used to provide the overall scan-enabled client module functionality described herein. Exemplary implementations of processor 122 include, but are not limited to, one or more single-core microprocessors, one or more multi-core microprocessors, and one or more programmable logic devices (e.g., a complex of programmable logic devices, a field-programmable gate array, etc.).

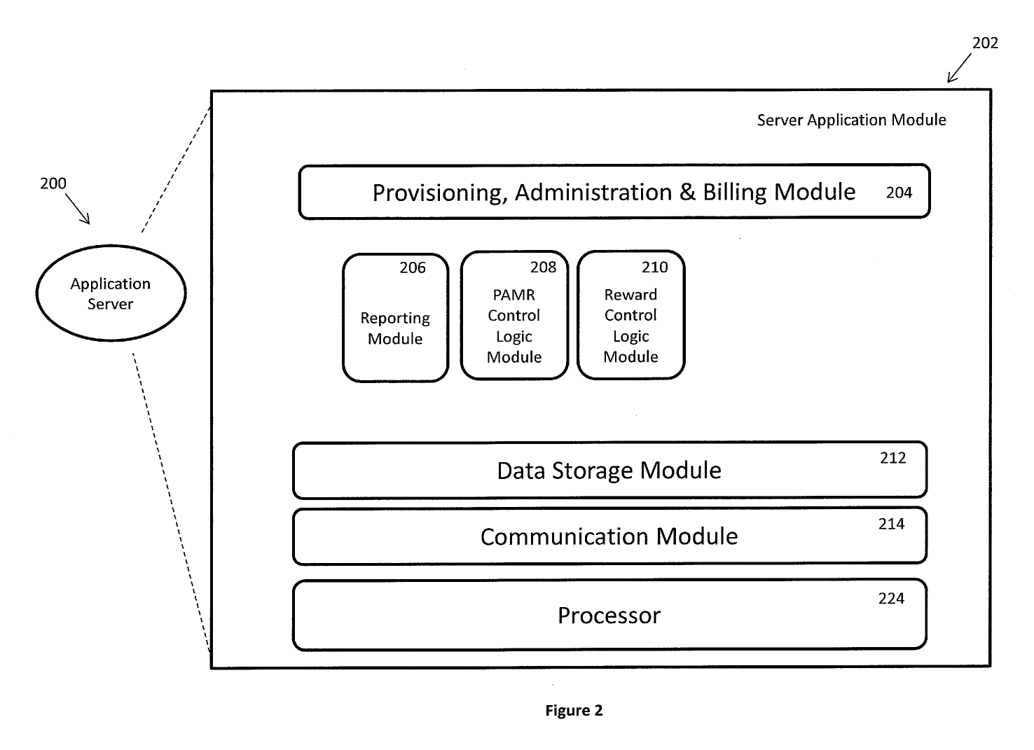

FIG. 2 is a block diagram that illustrates an exemplary architecture of a server application module 202, which resides and executes on a network or cloud-hosted application server 200. In the embodiment presented in FIG. 2, the server application module is comprised of a provisioning, administration and billing module 204, a reporting module 206, a PAMR control logic module 208, a reward control logic module 210, a data storage module 212, a communication module 214, and a processor 224. The purpose and function of each of these modules is described below. Server application module 202 executing on application server 200 makes application server 200 a special purpose computing platform that improves the functionality of application server 200 by configuring application server 200 to process received information extracted from a scanned PAMR instruction service scan code, and in some cases scanning user identification information and reference date/time information, and to provide the indicated PAMR instruction step service to the scanning user in response to receiving this information. As such, server application module 202 improves the technical fields of network access to services by providing such services automatically in response to receiving the scanned codes and with a reduced likelihood of data entry error, and also facilitates the efficient distribution of product associated instruction and reminder services via indicia that can be placed directly on an associated product or product package.

Provisioning, administration and billing module 204 is adapted to provide access for a PAMR instruction step administering entity to provision PAMR instruction step information, PAMR instruction step user subscription configurations/preference information, service configuration information, and compliance incentive reward content information. In the context of this disclosure, a user is considered to be the owner and/or operator of a mobile communication device (e.g., smartphone, tablet computer, etc.) that includes a scan-enabled client module, and is therefore capable of scanning a QR code (or other encoded, scanable code) and provide, trigger, initiate or facilitate access to the PAMR instruction step service.

In all of the embodiments disclosed herein, a scanning user may be granted or credited with a compliance incentive reward in response to the scanning or use of an associated scan-triggered PAMR instruction step service code (e.g., QR code). Exemplary compliance incentive rewards may include, but are not limited to, a digital or electronic coupon associated with a good or a service (e.g., 1$ off a large Joe's Coffee, etc.), a credit for an online game or gaming service, a credit for an online video, a music or video download. In one embodiment, such rewards may be credited or placed in a digital reward wallet associated with the user's scan-triggered service account, whereby the user can access and redeem a granted reward. In one embodiment, a reward granted to a user may be granted at a first value (e.g., $1 off next purchase) and subsequently modified to a second value (e.g., $2 off next purchase) at a later by Reward Control Module 210. In another embodiment, a “just in time” digital coupon reward may be granted and distributed to a user at a date/time that is proximal to a replacement or re-purchase reminder associated with a product.

Processor 224 is adapted to facilitate the execution of software and firmware associated with the operation of modules 204, 206, 208, 210, 212, 214 and 224 which is used to provide the overall server application module functionality described herein. Exemplary implementations of processor 224 include, but are not limited to, one or more single-core microprocessors, one or more multi-core microprocessors, and one or more programmable logic devices (e.g., programmable logic devices, field-programmable gate arrays, etc.).

According to one embodiment of the subject matter described herein, an identifier associated with a set of product associated instruction steps is encoded within a scanable code, such as an optical scan code (e.g., QR code) or NFC tag, which may be scanned by a user (e.g., a product/goods consumer, etc.). PAMR instruction steps may include, but are not limited to, product maintenance, product use guidelines and timeframes/time limits, product replacement interval/frequency, product cleaning interval/frequency, and product re-purchase or re-order interval/frequency. In one embodiment, each PAMR instruction step includes relative date and time offset scheduling information that can be evaluated and resolved to absolute dates and times in the presence of a reference date and/or time that is provided by or on behalf of a specific user (e.g., the scanning consumer/user). Various embodiments described in U.S. provisional patent filings that are incorporated by reference in this disclosure, refer to and describe exemplary implementations of such scan-triggered PAMR instruction step & reminder services in the form of PlantCareSquare, StoreSafeSquare, ChangeltSquare, and JITSquare branded services.

In one embodiment, PAMR instruction step information is logically organized into instruction sets or templates where, each set or template is associated with a specific set of PAMR instructions. In an alternate embodiment, each PAMR instruction set or template is associated with a user (e.g., a set of PAMR instructions for user X, etc.). PAMR instruction and reminder service identifiers, such as instruction set or template identifiers are used to map/associate/bind a provisioned PAMR instruction set or template with a scanable code, and this binding information is stored at or is accessible to a scan-triggered application server. Exemplary PAMR instruction set identifiers described previously include, a PlantCareSquareID identifier, a ChangeltSquareID identifier, a StoreSafeSquareID identifier and a JitSquareID identifier. In one embodiment, a PAMR instruction set identifier may be incorporated into the network address of a server that is hosting the scan-triggered PAMR instruction & reminder service. For example, information sufficient to identify a particular PAMR instruction set may be incorporated within or expressed within a domain name (e.g., PoweredByFlashback2324.com) associated with the scan-triggered PAMR instruction & reminder service. In another embodiment, information sufficient to identify a particular PAMR instruction set may be incorporated within or expressed in as an argument or parameter associated with a URL (e.g., PoweredByFlashback.com/webhp?sourceid=chrome-instant&PAMR_ID=2342). In any event, information extracted from a scanned PAMR instruction service scan code by a scanning mobile device is provided to the hosting PAMR instruction & reminder service server and this information is used, at least in part, to identify PAMR instruction set content.

In one embodiment, a “generic” PAMR instruction set or template that includes general instructions for an associated product may be defined and associated with a unique PAMR instruction set identifier that is assigned and/or maintained by a network application server that is hosting the scan-triggered PAMR instruction & reminder service. The PAMR instruction set identifier may be encoded within a scanable code, such as a QR code. Alternatively, the PAMR instruction set identifier may be mapped to or associated with a second, internal identifier, which is then encoded within the scanable code. In any case, the PAMR instruction set identifier encoded in the scanable code can be used, at least in part, by a scan-triggered application server of the present invention to identify a PAMR instruction set. In one exemplary embodiment, when such an identifier is received by the application server that is hosting the scan-triggered PAMR instruction & reminder service, the identifier is used to access the associated “generic” PAMR instruction set template and provide PAMR instruction step service to the scanning user. In one embodiment, a reference PAMR event time (e.g., date and time, 1/2/2016 @ 2:00 pm, date only, time only, etc.) is provided by and/or associated with a scanning user. Again, as used herein, a reference time may include date and time, date only, or time only and may be referred to within this and other disclosures as date/time for purposes of illustration and brevity. The scanning user's reference PAMR event date and/or time is applied to instruction step relative temporal scheduling offset information, such as date and/or time scheduling offset information, contained in the “generic” PAMR instruction set template, so as to generate a resolved temporal scheduling value for the scanning user. Exemplary resolved temporal scheduling values include, but are not limited to, absolute date/time (e.g., 5/6/2015 @ 1:00 pm), and a countdown timer value (e.g., 72 hours until the next PAMR instruction step needs to be performed). For the purposes of illustration, absolute date/time resolution is often referred to in the exemplary embodiments described herein, but it will be appreciated that any resolved temporal scheduling value could be used. This “generic” instruction step may be applied to any number of scanning users, and, as such, the same scanable QR code may be affixed to or otherwise displayed on all packages of the associated product. As each user scans this scanable code, they each provide their own reference date, which is then used to resolve the relative date/time offsets in the generic instruction set template such that different absolute instruction schedules are generated for each scanning user. Such resolved absolute instruction schedules may be dynamically created/re-created each time a user scans the PAMR instruction service scan code, or the resolved absolute instruction schedule may be determined once and stored for future use on each subsequent scan by the user.

In one embodiment, as each user scans a PAMR QR code, a user identifier is assigned to each user (if one has not already been assigned) and they are prompted to provide PAMR reference date/time information (e.g., product purchase date/time, most recent product replacement, etc.). The reference date and time provided by (or on behalf of) the user is associated with that user identifier and, in one embodiment, this association is stored in a binding record that is maintained or is accessible to the application server that is hosting the scan-triggered PAMR instruction step service. When the user makes subsequent scans of the same QR code, the user's user identifier (e.g., which may be stored in a cookie on the user's mobile device) is automatically communicated to the hosting scan-triggered server along with the PAMR instruction set identifier extracted from the scanable code, and the user identifier information is used to access that user's PAMR reference date/time. The PAMR instruction set identifier is used to access the associated “generic” PAMR instruction step template, and the user's PAMR reference date/time value is used to resolve the relative date/time scheduling offsets contained in the instruction step template, as described previously. The hosting server then communicates the date/time-resolved PAMR instruction step information to the scanning user, where it is displayed in chronological order. Current date/time information may be used to present the scanning user with those instruction steps that are most relevant at the current date/time (e.g., when the user scans the QR code, the current day/time instruction steps are displayed). In this embodiment, multiple copies of the same scanable code (e.g., a QR code associated with the changing of contact lenses, etc.) may be generated and printed or otherwise affixed to the packaging of the associated product. Packages of the product may be given to multiple different users, which each user may scan to obtain PAMR instruction step information that is date/time-resolved specifically for each user. This approach has significant advantages from the administrative perspective of the PAMR provider, as the same scan code can be printed on all packages of the same product, which are then distributed/sold to multiple different consumer users.

In an alternate embodiment, a “generic” PAMR instruction step template is defined and stored/accessible to the hosting scan-triggered application server. When a user initially scans the associated scanable code in a manner similar to that previously described and provides a reference PAMR event date and/or time, the scanning user's reference PAMR event date and/or time is applied to instruction step relative date/time scheduling offset information contained in the “generic” PAMR instruction set template, so as to determine absolute scheduling dates/times for the scanning user. In one embodiment, a copy of the “generic” template is created and associated with the scanning user (e.g., associated with the scanning user's identifier). This user-specific instance of the PAMR instruction step template includes resolved date/time information (that is determined based on the reference date/time provided by the user, in a manner similar to that previously described). Once created, this user-specific instance of the PAMR instruction set may be modified. Such modifications do not impact the “generic” template, but instead are associated with a specific user. Again, one key advantage of this approach is from an administrative perspective. For example, the same QR code can be printed on all packages of the same product, which are then distributed/sold to multiple different consumer users. Once each user scans the QR code and their user identifier is provided to the hosting scan-triggered application server (along with the PAMR instruction set identifier and their reference date/time information), the user's copy of the instruction set can be edited so as to change/delete any of the instruction steps for that user or add new steps.

In another embodiment, unique instruction sets may be created and/or maintained by the hosting scan-triggered server for each user, and a unique PAMR instruction set identifier assigned to each user-specific instruction set. In one embodiment, each scanable code (e.g., QR code) generated includes a different, unique PAMR instruction set identifier value, which has been or can be assigned to a specific user. This approach inherently requires the creation of multiple, unique QR codes (e.g., each user who is using a particular product would be given a QR code that includes a unique/different PAMR instruction set identifier value). The advantage of this approach offers involves the elimination of the need to for the scanning user to be assigned and to provide a user identifier, and as such, the described PAMR instruction step services can be provided in an anonymous manner. In one embodiment, the associated PAMR procedure reference date/time may be provided/collected in a manner similar to that previously described, or alternatively, reference date/time information may be pre-provisioned for a unique QR code via a provisioning interface available to a PAMR provider. As such, a user could simply be given a pre-provisioned, unique scanable code, which does not require them to provide user identification or reference date/time information.

In various embodiments, scanning user identifying information may include, but is not limited to, a user identifier assigned by the hosting scan-triggered application server (or service provider), such as for example, a username, email address, phone number, scan-triggered service account identifier, a randomly generated identifier, or a mobile device identifier (e.g., an identifier, which may be assigned by a scan-triggered server/service provider, that is stored in a cookie on a mobile device associated with the user or user, etc.).

In one embodiment, information that can be used to identify a network application server that is hosting or providing the scan-triggered PAMR instruction & reminder service is also encoded within the scanable code. In one example, such network application server identifying information may include, but is not limited to, an Internet protocol address, a network server address, a network resource address, and a uniform resource locator or identifier and/or associated parameters and argument values. This approach is advantageous in that a user or user is not required to download and install a native application that is designed specifically to provide PAMR instruction step & reminder service, and instead, any generic QR code scanner application residing on the user's mobile device is inherently capable of accessing various embodiments of the scan-triggered PAMR instruction step and reminder service of the present subject matter.

In one embodiment, PAMR instruction set compliance (i.e., has the instruction step been successfully completed) may be self-reported by a scanning user. For example, following the scan of a PAMR instruction step associated QR code, the scanning user is presented with a chronologically ordered list of PAMR instruction steps, where each instruction step includes a tap-able compliance indicator control (e.g., check box, etc.). Instruction step information provided to the scanning user is aligned to the current date/time at the time of the scan (i.e., instruction(s) relevant at the time of the scan are highlighted or preferentially displayed). When tapped or selected by the user, compliance information for the associated step (e.g., user identifier, instruction step identifier, date/time, etc.) is communicated to the hosting scan-triggered application server, where it is stored in a record that is associated with or bound to the user. In another embodiment, a user scan of a PAMR instruction set QR code causes associated PAMR instruction set identifier and user identifier information to be communicated to the hosting scan-triggered application server, where it is implicitly interpreted by the server as a compliance indication signal.

In one embodiment, a compliance incentive reward is associated with timely completion of one or more PAMR instruction steps. Compliance incentive reward criteria and associated digital reward(s) are associated or bound to a PAMR instruction set or template. If a user scans a PAMR instruction set QR code and signals compliance so as to satisfy the associated compliance incentive reward criteria, a digital reward is credited. In one embodiment, a granted compliance incentive reward may be credited to a digital reward wallet associated with the user. Exemplary digital rewards may include, but are not limited to, a digital coupon for a good or service, an online game credit (e.g., a credit for a free game, a credit for a game “mod” (e.g., Minecraft mod, etc.)), an online game asset credit (e.g., a credit for a virtual asset associated with an online game, such as an extra life, extra points, extra power, extra playing time, etc.), an online video streaming credit, an online streaming music credit. With regard to online game, video and music related rewards, it will be appreciated that the associated online game, video or music services may be provided by a game or media content server other than the scan-triggered PAMR service application server. Such online game, video or music credits may, for example, be automatically, immediately redeemed at the time of issuance or the reward credits may be placed in a digital reward wallet associated with the user.

In one embodiment, a compliance guardian is associated with a user and one or more PAMR instruction steps. A message notifying the compliance guardian that the associated user is non-compliant/has not reported compliance of the associated PAMR instruction step is generated and transmitted. For example, a mobile phone number associated with a compliance guardian may be provisioned, such that the designated compliance guardian receives a text message notifying them of the user user's non-compliance. In another embodiment, the non-compliance notification message may be communicated to the compliance guardian via a social network message post (e.g., Facebook post) or a social media messaging service, such as Twitter using a tweet. The operations of identifying non-compliance with a PAMR instruction step and sending the message notifying the user or the compliance guardian may be performed or implemented by server 200.

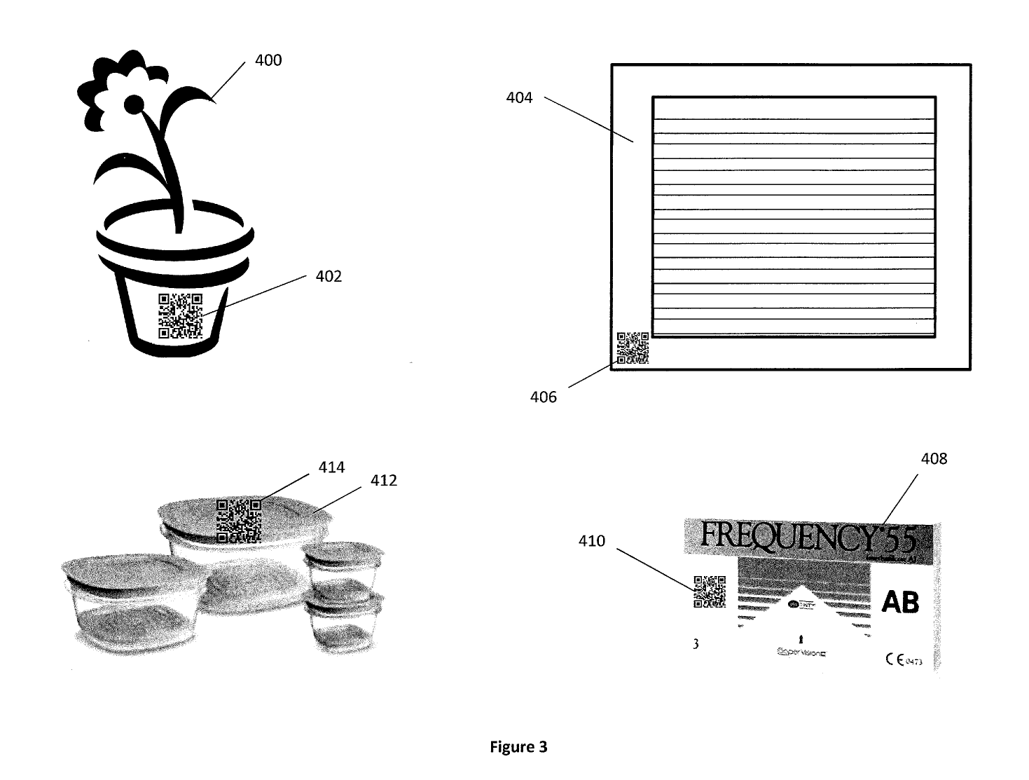

FIG. 3 generally illustrates several exemplary embodiments and associated product deployments of PAMR instruction and reminder service. In one exemplary embodiment referred to in related prior disclosures as PlantCare Square service, a suitably provisioned PAMR service code 402 (e.g., QR code, NFC tag, etc.) is associated with a plant product 400 that requires active user maintenance and care. When scanned by a user, PAMR service code 402 is adapted to cause the user's scanning mobile device to establish a connection with an associated scan-triggered server that is hosting the PAMR service. In one embodiment, information that identifies or can be used to identify the hosting scan-triggered PAMR server is encoded within scanable PAMR service code 402. Exemplary information that identifies or can be used to identify the hosting scan-triggered PAMR server may include, but is not limited to, a uniform resource locator (URL), a uniform resource identifier (URI), a network server address, an Internet protocol (IP) address, etc. In one embodiment, PAMR service code 402 may also include encoded information that identifies or can be used to identify a merchant, retailer, product manufacturer, product distributor, product reseller, or other client entity that is associated with the product. It will be appreciated the above description and associated discussion applies, in general, to most any PAMR service embodiment.

Once a connection has been established between the scanning user's mobile device and the hosting scan-triggered PAMR server, encoded information that is extracted from the PAMR service code is communicated to the hosting PAMR server. If it has already been assigned, user identifier information is also provided to the hosting PAMR server. User identifier information may include, but is not limited to, a mobile device identifier, a username, an email address, a messaging service identifier, a phone number. In one embodiment, the provided user identifier information may be selected or provided by the associated user. In another embodiment, the provided user identifier may be stored on the user's mobile device (e.g., in a cookie) and may be automatically provided at or near the time of the PAMR server connection establishment. In another embodiment, the PAMR server may generate and assign a unique user identifier to the user. The user may also provide contact preference information (e.g., email address, Twitter handle, text message address, phone number, etc.) that can be subsequently used by the hosting PAMR server to provide PAMR instruction step reminder notifications to the user. The user may also provide contact information associated with a compliance guardian, where the compliance guardian is notified by PAMR server in case the user has not signaled compliance with a PAMR instruction step.

With particular regard to PAMR service code 402, when initially scanned and the associated PAMR service is activated or engaged by the scanning user, the hosting PAMR server is adapted to collect or otherwise determine a reference date/time with which a relative date/time offset plant care schedule can be resolved to determine an absolute plant care schedule for the user. For example, when the user scans PAMR service code 402, a reference date/time is either provide or specified by the user, or the hosting server may automatically determine or implicitly assume an associated reference date/time, for instance, based on the date/time of the user's scan. The PAMR server then applies the user's reference date/time to the associated PAMR instruction and reminder schedule, which includes instruction and reminder schedule relative date/time offset information (e.g., relative frequency of occurrence, day of week occurrence, etc.). The PAMR server resolves the relative date/time offsets in the associated PAMR instruction and reminder schedule set or template, so as to obtain absolute instruction and reminder schedule information for that user. This absolute schedule information may be stored for later use by the PAMR server or may be discarded after use and recalculated on-demand/as needed. In any event, current day/time aligned PAMR instruction and reminder schedule information is communicated to the scanning user. In one embodiment, one or more electronic calendar event invitations associated with PAMR instruction and reminder steps may also be generated and sent to the user (e.g., via an Internet Calendaring Service (ICS) formatted file attached to an email message). In another embodiment, text message reminders associated with PAMR instruction and reminder steps may also be set for and subsequently communicated to the user at the appropriate dates/times.

As such, the scanning user is provided with a “customized” plant care schedule and associated plant maintenance reminder notifications. In one embodiment, the user can signal compliance with an instruction step by scanning the same PAMR service code 402. In this case, the hosting PAMR server may be configured so as to interpret receipt of the scan service code and user identifier information as an implicit instruction step compliance signal. In another embodiment, the hosting PAMR server may collect additional information from the user at or near the time of the scan that identifies the particular instructionstep(s) that have been complied with. In one embodiment, a just in time (JIT) reward (e.g., digital coupon) may be granted to the user at or near the date/time of an associated PAMR instruction step. For example, PAMR instructions may include a step that requires fertilization of the associated product at a relative occurrence frequency that corresponds to 6 month intervals. Once a reference date/time has been provided or determined and a corresponding absolute fertilization schedule has been calculated for the user, PAMR server is adapted to grant a digital coupon for a bag of fertilizer (e.g., 10% your next purchase of a 10 lb bag of HardiGrow Plant Fertilizer) to the user at a date/time that is proximal to the date/time of the required fertilization instruction step for the user. As such, a digital coupon for a relevant associated product is provided to the user at a time when the user would be most likely to make use of it. Such rewards are referred to herein and in associated prior disclosures as just in time (JIT) rewards.

In another exemplary product deployment scenario, a heating ventilation and air conditioning (HVAC) system air filter element 404 includes a PAMR instruction and reminder service code 406. Code 406 may, for example, be printed on the air filter element as a QR code or may be printed/affixed to the packaging of the air filter element. In this example, scanning of PAMR service code 406 by a user triggers the collection or association of a reference date/time. In this case, the reference date/time is used to resolve one or more air filter inspection, cleaning, replacement and re-order scheduling date/time relative offset rules that are maintained by the hosting PAMR server. Alternatively the user may select from one or more air filter inspection, cleaning, replacement and re-order scheduling date/time relative offset tuple options, which are then resolved using the reference date/time information. PAMR server then calculates or generates a customized, absolute schedule for the user. The user is subsequently provided with the calculated filter inspection, cleaning, replacement and re-order schedule, and associated reminders and JIT rewards, in a manner similar to that described above.

In another exemplary product deployment scenario, a package of disposable/soft contact lenses 408 includes a PAMR instruction and reminder service code 410. Code 410 may, for example, be printed on the contact lens package as a QR code. In this example, scanning of PAMR service code 410 by a user triggers the collection or association of a reference date/time. In this case, the reference date/time is used to resolve one or more soft contact lens cleaning, replacement and re-order scheduling date/time relative offset rules that are maintained by the hosting PAMR server. Alternatively the user may select from one or more soft contact lens cleaning, replacement and re-order scheduling date/time relative offset tuple options, which are then resolved using the reference date/time information. PAMR server then calculates or generates a customized, absolute schedule for the user. The user is subsequently provided with the calculated soft contact lens cleaning, replacement and re-order schedule, associated reminders and JIT rewards, in a manner similar to that described above.

In another exemplary product deployment scenario, a re-usable food storage container 412 (e.g., Gladware® food storage container, Tupperware® food storage container, etc.) includes a PAMR instruction and reminder service code 414. Code 414 may, for example, be printed on the lid or side of a re-usable food storage container as a QR code. In this example, scanning of PAMR service code 414 by a user triggers the collection or association of a reference date/time. In this case, the reference date/time is used to resolve one or more “use-within” scheduling date/time relative offset rules that are maintained by the hosting PAMR server. Alternatively the user may select from one or more “use-within” scheduling date/time relative offset tuple options (e.g., use within 48 hours, use within 1 week, etc.), which are then resolved using the reference date/time information. PAMR server then calculates or generates a customized, absolute “use-by” schedule (e.g., use by 5/1/2015 @ 7 pm) for the user. The user is subsequently provided with the calculated “use-by” schedule and associated reminders, in a manner similar to that described above. In one embodiment, if the user subsequently scans PAMR service code 414 after the specified/calculated “use-by” date, PAMR server 200 communicates an alert notification message to the user, which quickly lets the user know that they should discard the contents of the associated food storage container.

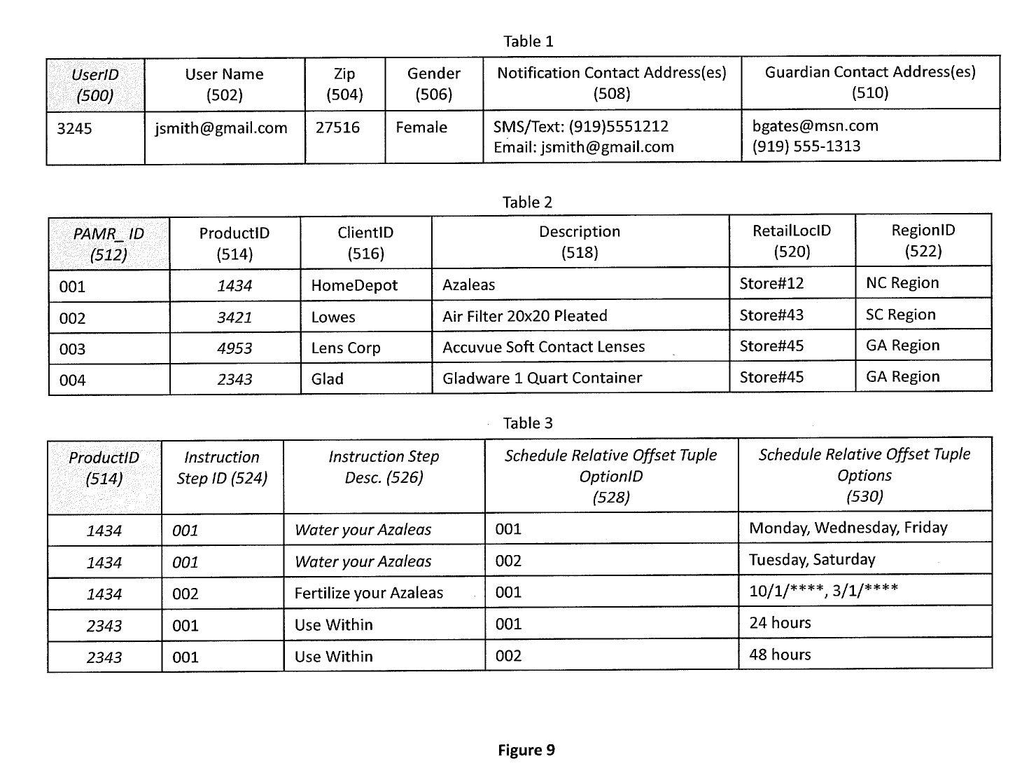

Described below are various exemplary embodiments of scan-triggered PAMR instruction step service of the present subject matter. Presented in FIGS. 9-11 is exemplary provisioning and transaction data associated with various exemplary embodiments of the present subject matter. FIG. 9, Table 1 includes exemplary PAMR instruction and reminder service user information including a user identifier 500, user name identifier 502, geolocation information 504, gender information 506, contact/notification address identifier 508, and a compliance guardian/notification address identifier 510. Table 2 describes exemplary PAMR instruction and reminder set or template information, which includes a PAMR_ID identifier 512, a ProductID identifier 514, a Client entity identifier 516 (e.g., scan-triggered PAMR service client, merchant, retailer, product manufacturer, distributor, re-seller, etc.), product description information 518, retail location information 520, and distribution region information 522. Table 3 includes exemplary PAMR instruction set or template information that includes PAMR instruction and reminder steps and associated relative offset schedule tuple options. Table 3 includes the ProductID identifier 514, an instruction step identifier 524, instruction step description information 526, instruction step schedule relative offset tuple option identifier information 528, and instruction step schedule relative offset tuple option criteria/description information 530.

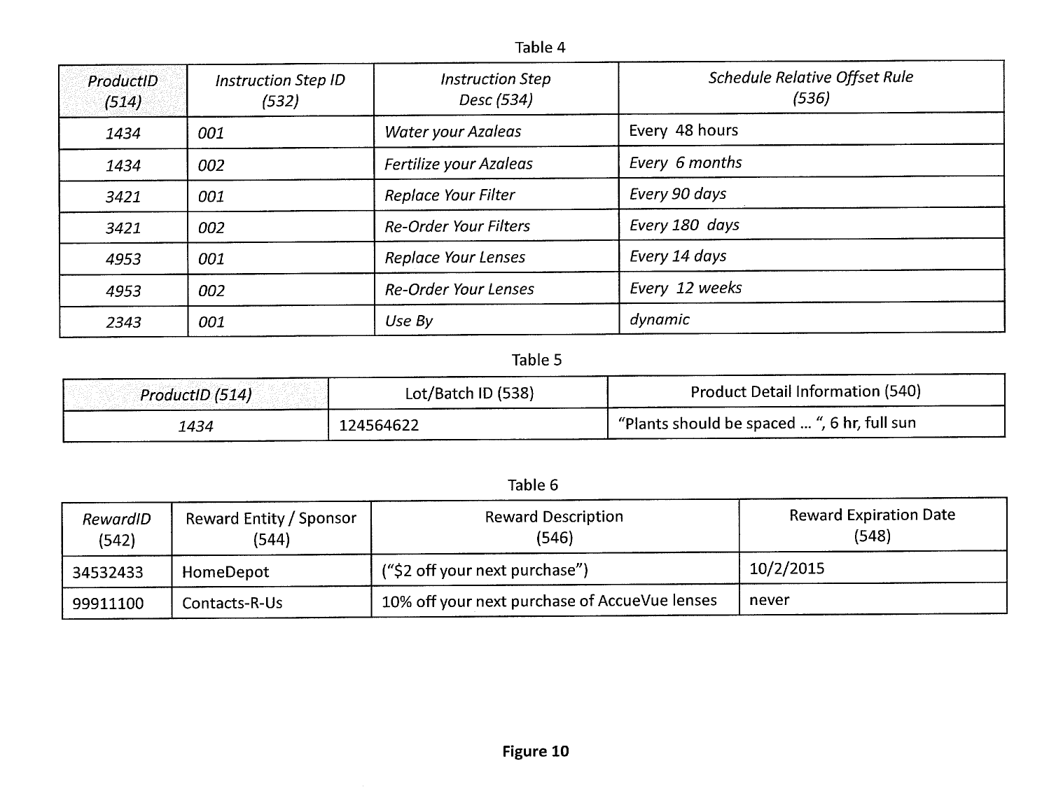

Shown in FIG. 10, Table 4 illustrates exemplary PAMR instruction and reminder steps and associated relative offset rules. Table 4 includes ProductID identifier 514, an instruction step identifier 532, instruction step description information 534, instruction step schedule relative offset rule criteria/description information 536. Table illustrates exemplary product information and includes ProductID identifier 514, product manufacturing batch/lot information 538, and product detail information 540, such as text, web URL, video link, and audio link resource information. Table 6 illustrates exemplary compliance and just in time (JIT) digital reward content, and includes a RewardID identifier 542, Reward sponsor entity information 544, Reward description information 546, and Reward expiration information 548.

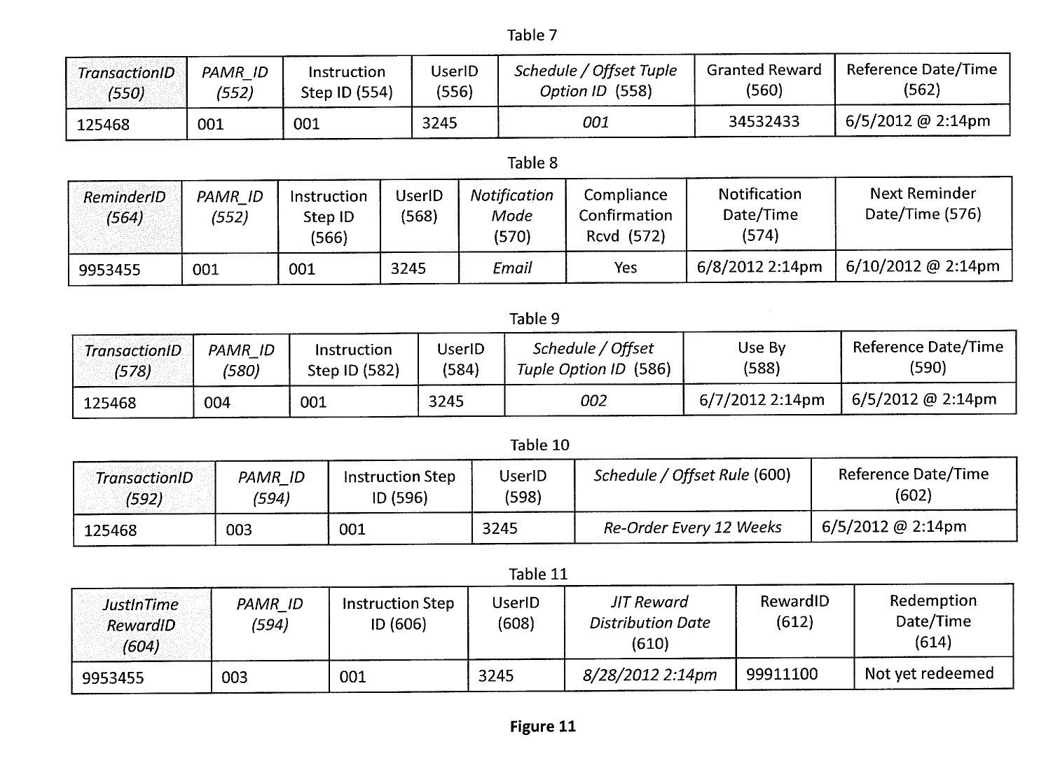

Shown in FIG. 11, Tables 7-11 present exemplary user scan transaction and PAMR service binding record information that may be maintained by a hosting scan-triggered PAMR server. Table 7 presents scan transaction and service binding information associated with an embodiment of the present subject matter that utilizes PAMR schedule offset tuple options, and includes identifier 550, a received PAMR_ID service code value 552, a PAMR instruction step identifier value 554, a user identifier value 556, a selected PAMR schedule relative offset tuple option identifier 558, a granted reward identifier 560, and a reference date/time value 562. Table 8 presents exemplary PAMR service binding information associated with instruction step reminder notifications, and includes a ReminderID 564, a PAMR_ID identifier value 552, instruction step identifier information 566, associated user identifier information 568, reminder notification mode information 570 (e.g., email, text, Tweet, social media post, etc.), user compliance confirmation indicator information 572, reminder notification timestamp information 574, and next scheduled reminder notification 576.

Table 9 presents exemplary scan transaction and service binding information associated with a re-usable food storage container embodiment of the present subject matter that utilizes PAMR schedule offset tuple options (e.g., use within 24 hours, etc.), and includes scan transaction identifier 578, a received PAMR_ID service code value 580, a PAMR instruction step identifier value 582, a user identifier value 584, a selected PAMR schedule relative offset tuple option identifier 586, resolved “use by” date/time value 588, and a reference date/time value 590.

Table 10 presents exemplary scan transaction and service binding information associated with an embodiment of the present subject matter that utilizes PAMR schedule offset rules, and includes scan transaction identifier 592, a received PAMR_ID service code value 594, a PAMR instruction step identifier value 596, a user identifier value 598, a selected PAMR schedule relative offset rule criteria or identifier 600, and a reference date/time value 602.

Table 11 presents exemplary just in time (JIT) reward distribution information including, a JustInTimeRewardID identifier 604, an associated PAMR_ID value 594, an associated PAMR instruction step identifier value 606, a user identifier value 608, a JIT reward distribution date 610, a digital RewardID identifier value 612, and reward redemption timestamp information 614.

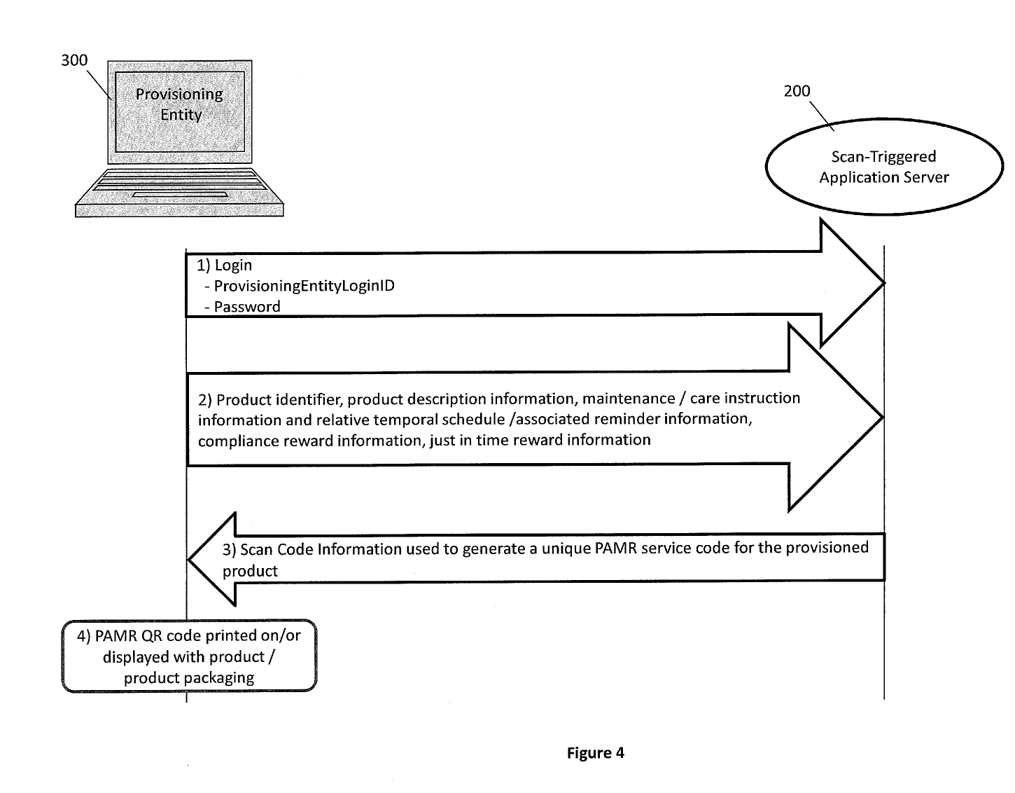

Shown in FIG. 4 is an exemplary embodiment of the present PAMR instruction and reminder service associated with a product or good, such as a consumer packaged good (CPG). (In previous associated disclosures, examples of this service were referred to as PlantCare Square, ChangeIt Square, StoreSafe Square, and JIT Square services.) A provisioning administrator 300 logs into a provisioning interface associated with scan-triggered PAMR instruction and reminder service application server 200 (step 1). In one embodiment, PAMR instruction and reminder service provisioning information, such as that shown in Tables 2-6 (along with other service data, not shown) is provisioned and stored/made accessible to hosting scan-triggered PAMR application server 200. A PAMR_ID is generated and associated with the provisioned product & product-specific instruction and reminder set or template, and an associated scanable code is created that includes the encoded PAMR_ID. In one embodiment, information that can be used to identify an application server associated with the PAMR instruction and reminder service is also encoded in the scanable PAMR service code (step 3). In one embodiment, information that can be used to a Client entity (e.g., a retailer, a product manufacturer, a distributor, a re-seller, etc.) is also encoded in the scanable PAMR service code. In the embodiments referred to above, the scan-triggered application server identifier and Client entity identifier information may be encoded within, appended to, or otherwise incorporated within a PAMR_ID value. The PAMR service code may, for example, be deployed as a QR code that can be printed on an associated product or the associated product's packaging (step 4).

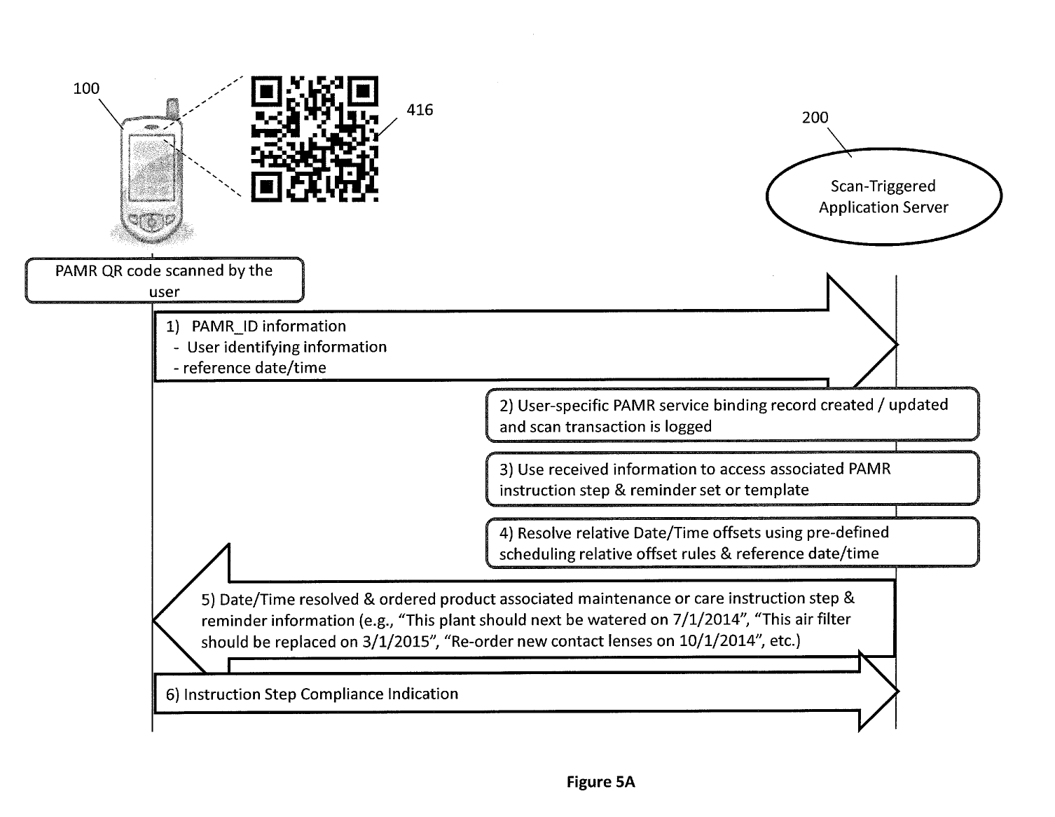

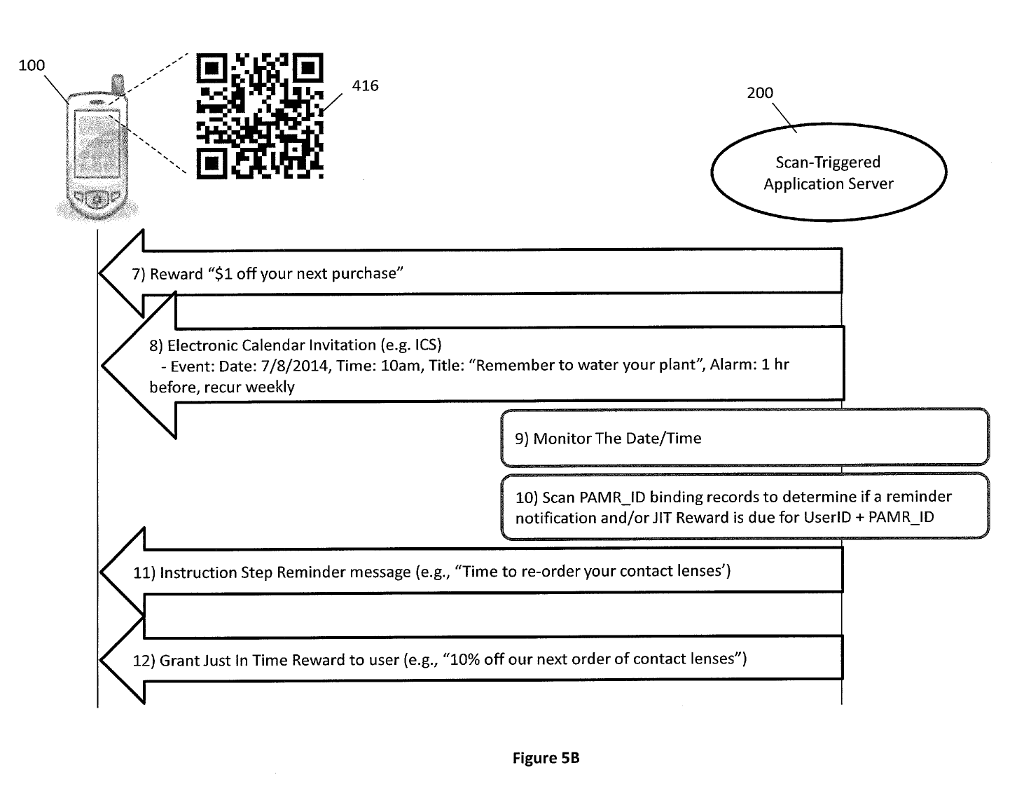

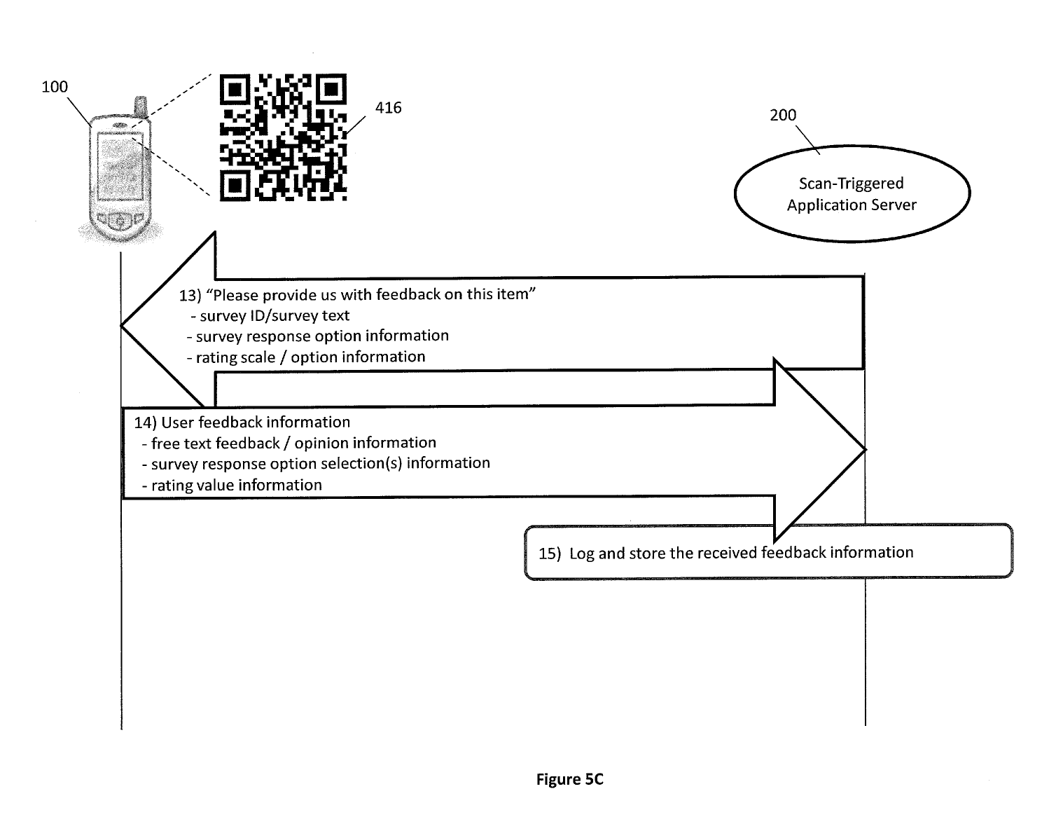

Shown in FIGS. 5A-5C is an exemplary information and process flow diagram associated with one embodiment of the present scan-triggered PAMR instruction and reminder service, which includes a scanning user's mobile device 100, where the scanning use may be a product consumer, a PAMR instruction and reminder service scan-code 416 and scan-triggered PAMR instruction and reminder application server 200. In step 1, user/mobile device 100 scans code 416 for the first time. A PAMR_ID value encoded within the scan code is extracted by the scanning mobile device and communicated to server 200, in the form of a PAMR instruction and reminder service request. In various embodiments, which apply to all of the examples described herein, a PAMR instruction and reminder service request may be comprised of a single message or multiple messages. Also communicated to server 200 is a user identifier or user identifying information. For example, such user identifying information may be obtained, at the time of the scan, from a login credential cookie that was previously placed on the user's mobile device by server 200, a mobile device identifier associated with mobile device 100, or may be manually entered by the scanning user. Reference date/time information is also communicated to or determined by server 200. For example, a reference date/time may be manually entered by the scanning user or may be automatically communicated to server 200 by the user's mobile device, or the server 200 may implicitly determine the reference date/time based on the date/time that scan information was received from the scanning user, or from transmit timestamp information contained in the messages received from mobile device 100. Exemplary reference date/time information may be associated with a product purchase date/time, a product use date/time, or other date/time associated with the product or use of the product, etc. In step 2, the received PAMR_ID, user identifier information, and reference date/time information are associated/correlated and stored in a binding record by PAMR control logic module 208 on server 200. Exemplary user binding record information is shown in Tables 7-11. In step 3, the received PAMR_ID (e.g., 001) is used by module 208 to access store product-specific instruction set or template information, such as that shown in Tables 2-5. In step 4, the received or determined reference date/time information is applied to the associated product instruction set or template information, so as to resolve the relative date/time offsets for each instruction step to an absolute date/time for the scanning user. In step 5, the resolved, chronologically ordered product-associated instruction step schedule information is communicated to the scanning mobile device 100 and displayed to the user on-screen. In one embodiment, current date/time information at the time of the scan is used to align or synchronize the presented instruction step information to the current date/time. For example, if the user scans the QR code at 8:30 am on 4/24/2015, the instruction step information that is communicated and displayed is aligned to the instruction step or steps that are scheduled at or near 8:30 am on 4/24/2015. In one embodiment, instruction steps that occur in the future can be viewed by the user by browsing forward in time through the chronologically ordered instruction step information provided by server 200, and likewise steps that occur in the past may be viewed by browsing backwards in time.

In one embodiment, the resolved instruction step schedule information associated with the scanning user is stored in a user-specific binding by module 208 once it is computed, such as is shown in the next reminder date/time field of Table 8, and use-by field of Table 9. In other embodiments, only the user's reference date/time is stored by module 208, and absolute instruction step schedule information for the user is re-computed “on the fly” each time the user subsequently scans code 416. In one embodiment, an instruction step associated with the user may be added/deleted or modified/customized, such that the customization of steps in an instruction set or template is associated only with the user. Such instruction step customizations may be performed by the user or an administrator on behalf of the user, and are stored in a binding record associated with that user. As such, only the user will see instruction set or template customizations associated with the user, when code 416 is scanned (i.e., other users who scan code 416 will not see or be presented with the user's customizations).

In step 6, mobile device 100 may signal module 208 that one or more instruction steps have been completed by sending an instruction step compliance signal or indication, where the instruction step compliance indication includes information sufficient to identify the complied with instruction step(s). In step 7, reward control logic module 210 is adapted to receive and/or process instruction step compliance indication information associated with the user and, based on provisioned instruction compliance incentive reward rules, grant the user a compliance incentive reward. Compliance incentive rewards may include any of the types discussed and described previously in this and other disclosures associated with the present subject matter (e.g., digital coupons, online games, video, music, entertainment services, etc.). In exemplary embodiments, granted compliance rewards may be automatically instantly redeemed at the time of grant, or may instead be credited to a digital reward wallet associated with the user's scan-triggered PAMR instruction and reminder service account and redeemed at the user's discretion.

In step 8, module 208 is adapted to generate electronic calendar “reminder” event invitations (e.g., Google Calendar invitations, etc.) associated with one or more of the PAMR instruction steps associated with scan code 416. Such electronic calendar reminder event invitations may be created using standard, well-known electronic calendaring protocols, such as iCalendar or other standardized formats. Such instruction step reminder event invitations may be communicated to the user via mobile device 100 via email, text message service, social media messaging service, etc. If the user accepts the associated instruction step event invitation, the associated instruction step reminder event is placed on the user's electronic/Internet calendar (e.g., Google Calendar, etc.) and associated reminder alarms may fire at the appropriately designated dates/times so as to remind the user to complete one or more PAMR instruction steps.

In step 9, module 208 on server 200 is adapted to monitor the passage of time following the user's initial scan of code 416. In steps 10 and 11, module 208 is adapted to generate and transmit reminder notification messages to the user via mobile device 100 (e.g., via email, text message, social media message post, Twitter, etc.) for those instruction steps that the user has not yet signaled/indicated as being complied with/completed. Exemplary reminder notification message information is shown in Table 8.

In step 12, module 208 is adapted to monitor the passage of time and identify those PAMR instruction steps that are potentially associated with the re-ordering or re-purchasing of the associated product. For example, a PAMR instruction step may include a reminder to re-order a 6-pack of contact lens product every 12 weeks. Module 208 determines for the user that the user's 12 week re-order reminder is near/approaching, and coordinates with Reward control logic module 210 to distribute a digital reward (e.g., digital coupon) for an associated contact lens product (e.g., 10% off your next contact lens order). Such a reward is referred to herein as a “just in time” (JIT) reward, and it is one that is distributed as an associated product re-purchase/re-order reminder point nears for a user. With such JIT rewards, a relevant digital coupon is provided to a consumer at a point in time where interest in purchasing the associated product is potentially high.

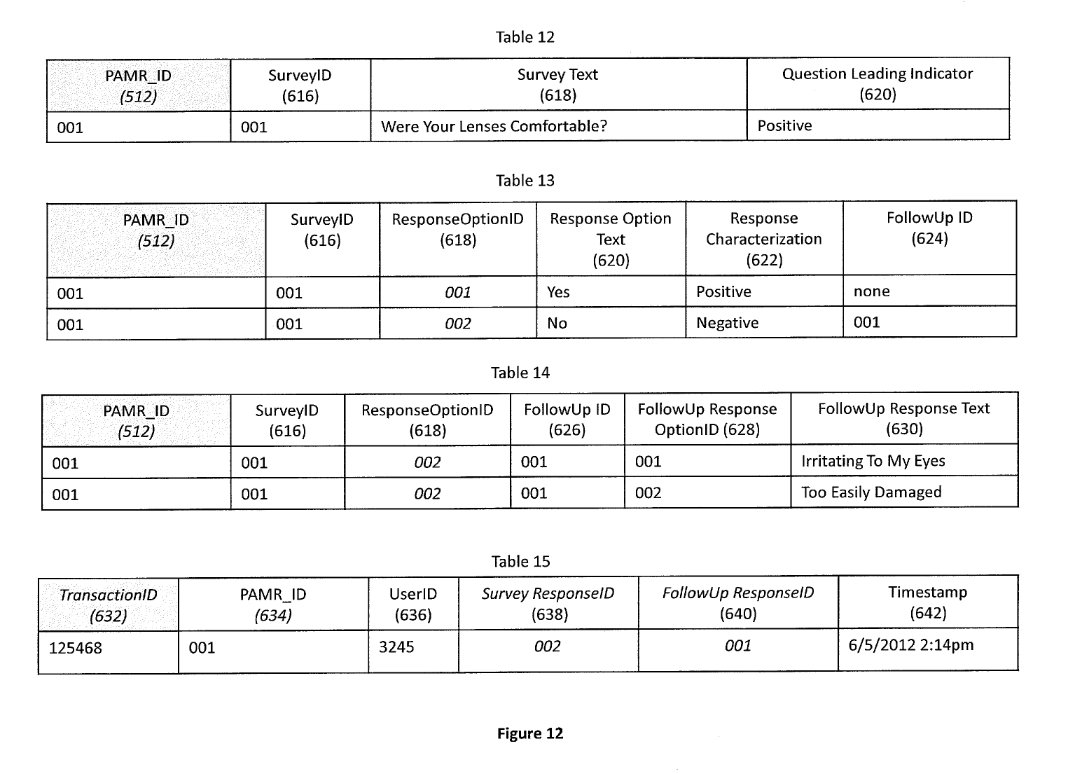

In step 13, server 200 presents the user with associated product feedback survey content, which may include survey question and response option content. Exemplary PAMR product survey content is shown in Tables 12-14 of FIG. 12. Table 12 includes PAMR_ID identifier information 512, a product survey identifier 616, product survey text 618, question leading indicator 620 (i.e., is the survey question presented as a leading question in a positive, negative or neutral direction?). Table 13 includes associated survey response option content, including PAMR_ID identifier 512, survey identifier 616, response option identifier 618, response option text 620, response characterization indicator 622 (e.g., is the response option considered a positive response, a negative response, or a neutral response?), and a follow-up question identifier 624. Table 14 contains follow-up question/response option content and includes, PAMR_ID identifier information 512, a survey identifier 616, a response option identifier 618, a follow-up survey identifier 626, a follow-up survey response identifier 628, and follow-up response text 630. Tables 16 and 17 illustrate product rating feedback survey content associated with a product. Table 16 includes PAMR_ID identifier information 512, rating scale identifier information 644, rating scale text 646. Table 17 includes PAMR_ID identifier information 512, rating scale identifier information 644, rating scale lower boundary information/content 648, and rating scale higher boundary information/content 650.

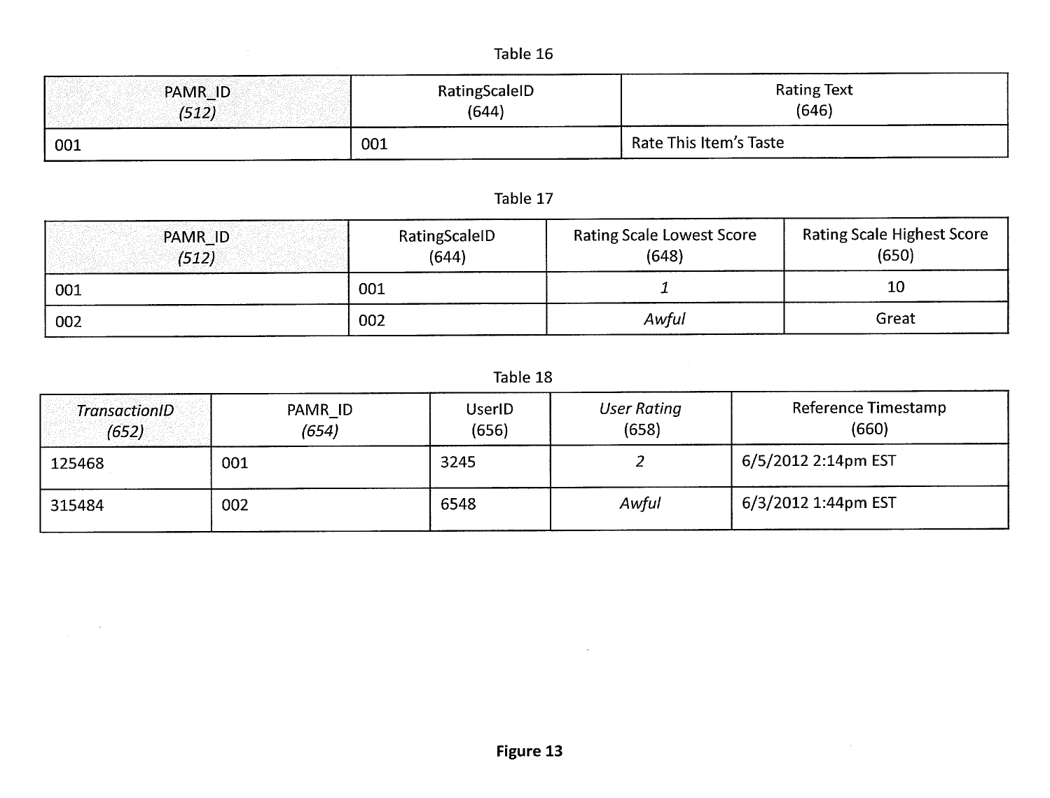

In step 14, user, using mobile device 100, responds to the product survey solicitation by server 200. In one embodiment, the user simply selects from among one or more possible survey response options that are provided by server 200. In another embodiment, the user may input free text or record an audio response to the survey question. Shown in FIG. 12, Table 15, is an exemplary user scan transaction and PAMR service binding record information that may be maintained by a hosting scan-triggered PAMR server, which includes user feedback survey response information (step 15). Table 15 includes transaction identifier 632, an associated or received PAMR_ID service code value 634, a user identifier value 636, a feedback survey response identifier 638, a follow-up survey identifier 638, a follow-up response identifier 640, and response timestamp information 642. Shown in FIG. 13, Table 18, is an exemplary user scan transaction and PAMR service binding record information that may be maintained by a hosting scan-triggered PAMR server, which includes user feedback survey rating response information. Table 18 includes transaction identifier 652, an associated or received PAMR_ID service code value 654, a user identifier value 656, a user rating value 658, and response timestamp information 660.

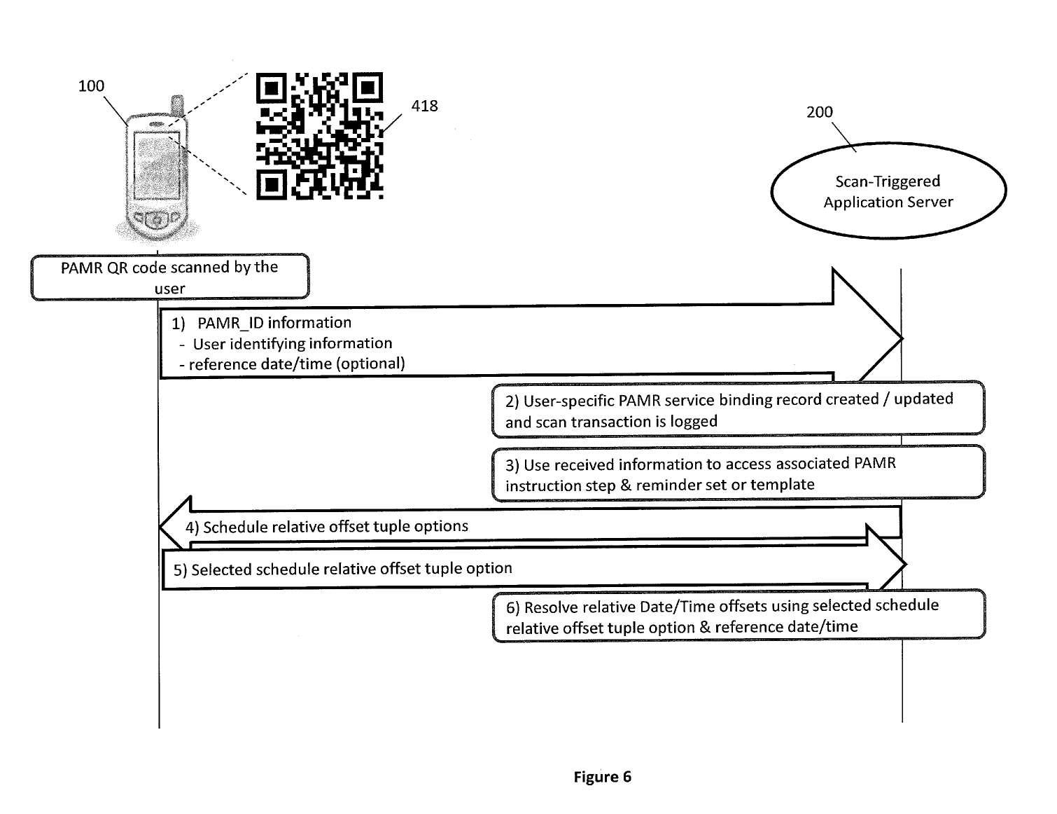

Shown in FIG. 6 is an exemplary processing and information flow diagram associated with another embodiment of the present PAMR service subject matter, where a scanning user is presented with one or more possible PAMR scheduling options in response to a PAMR service code scan. In step 1, user/mobile device 100 scans PAMR service code 418 for the first time. A PAMR_ID value encoded within the scan code is extracted by the scanning mobile device and communicated to server 200, in a manner similar to that previously described. Also communicated to server 200 is a user identifier or user identifying information, as described previously. Reference date/time information is also communicated to or determined by server 200, in a manner similar to that previously described. In step 2, the received PAMR_ID, user identifier information, and reference date/time information are associated/correlated and stored in a binding record by PAMR control logic module 208 on server 200. Exemplary user binding record information is shown in Tables 7-11. In step 3, the received PAMR_ID (e.g., 001) is used by module 208 to access store product-specific instruction set or template information that includes schedule relative offset option tuples, such as that shown in Table 3. In step 4, the associated schedule relative offset options are communicated to the scanning user (e.g., the options are displayed as tap-able buttons on a smartphone touchscreen, etc.). In step 5, the user, using mobile device 100, selects a schedule relative offset option, and information that can be used by server 200 to identify the selected option is communicated to server 200. In step 6, module 208 uses the received or determined reference date/time information, along with the schedule relative offset option selection and date/time resolution processing is applied to the associated product instruction set or template information, so as to resolve the relative date/time offsets for each instruction step to an absolute date/time for the scanning user that conforms to the user's relative offset tuple selection. Once this initial setting is specified by the user, subsequent instruction step reminder and other processing (e.g., rewards, etc.,) proceeds in a manner that is similar to that described previously, and hence is not repeated here.

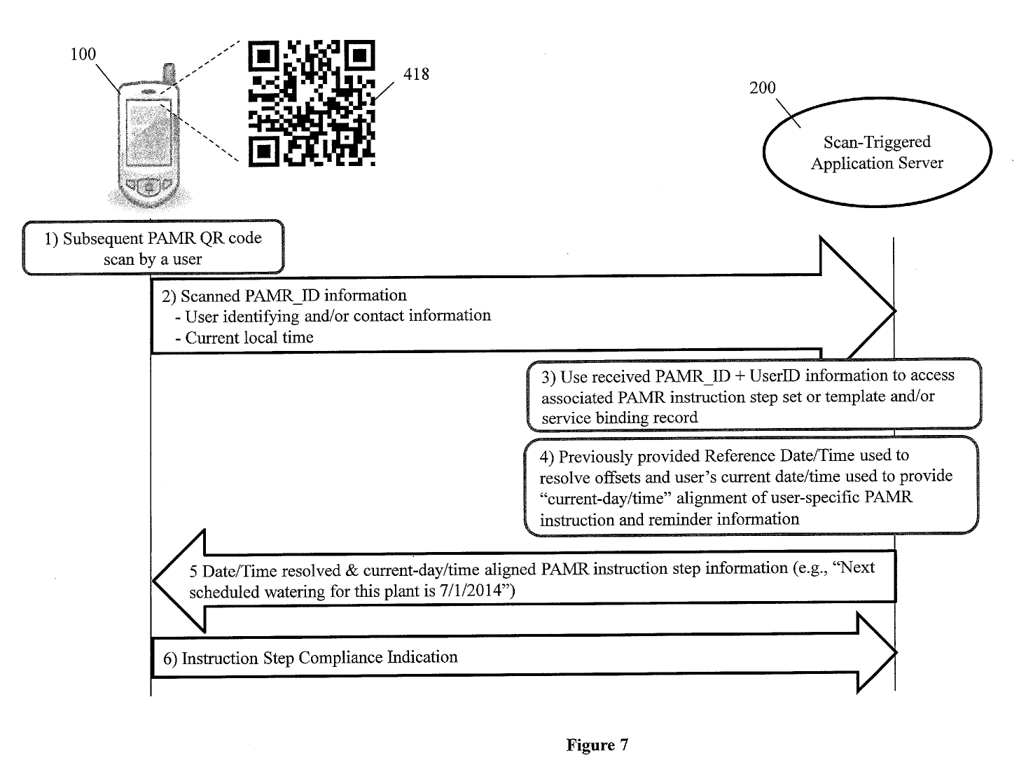

Presented in FIG. 7 is an exemplary information and process flow diagram associated with a subsequent scan of PAMR service code 418 by user using mobile device 100 according to one embodiment of the present scan-triggered PAMR instruction and reminder service. In step 1, user/mobile device 100 scans code 302 subsequent to the initial scan (as illustrated in FIG. 6). In step 2, the PAMR_ID value encoded within scan code 418 is extracted by the scanning mobile device and communicated to server 200, in a manner similar to that previously described. Also communicated to server 200 is a user identifier or user identifying information. Current local date/time information may also be communicated to server 200, or server 200 may consult an alternate time source to obtain current date/time information. In one embodiment, the received PAMR_ID information is used to access the associated instruction set or template, and the user identifier information is used to access the previously created user-specific binding record to obtain the user's associated reference date/time information (step 3). The reference date/time information is then applied to the instruction set or template to resolve the relative date/time offsets for the user, as previously described (step 4). In another embodiment, the user identifier is used to access previously resolved instruction step schedule information that was stored by and is accessible to module 208. In step 5, the resolved, chronologically ordered instruction step schedule information is communicated to the scanning mobile device 100 and displayed to the user on-screen. In one embodiment, current date/time information at the time of the scan is used to align or synchronize the presented instruction step information to the current date/time, in a manner similar to that previously described. In step 6, mobile device 100 signals module 208 that one or more instruction steps have been completed by sending an instruction step compliance signal or indication, where the instruction step compliance indication includes information sufficient to identify the complied with instruction step(s). Compliance incentive rewards also may be granted and distributed, in a manner similar to that previously described.

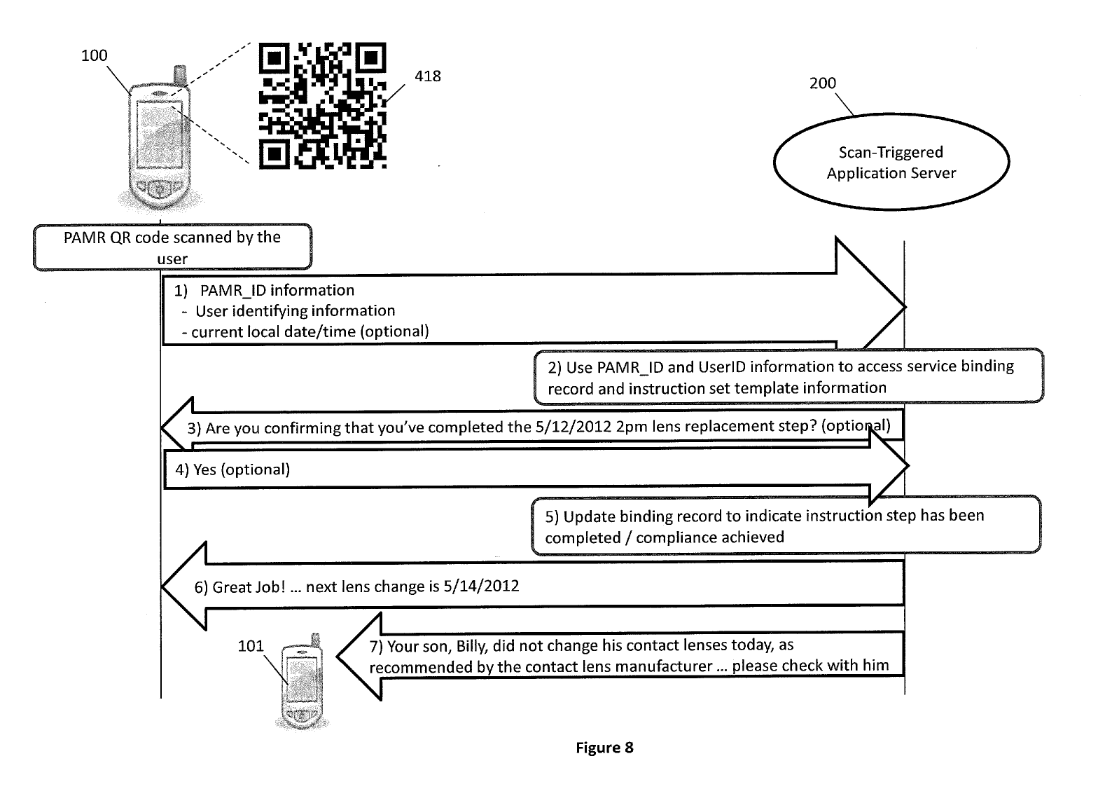

Presented in FIG. 8 is an exemplary information and process flow diagram associated with a subsequent scan of PAMR service code 418 by the user using mobile device 100, where the scan is intended to signal compliance with an associated PAMR instruction step/reminder. In step 1, user/mobile device 100 scans code 418 subsequent to an initial scan (as illustrated in FIG. 6). In step 2, the PAMR JD value encoded within scan code 418 is extracted by the scanning mobile device and communicated to server 200, in a manner similar to that previously described. Also communicated to server 200 is a user identifier or user identifying information.

Also it will be appreciated that upon the initial scan to become a new user of the PAMR instruction and reminder service, the user may choose to access the service(s) in a mode that does not require an explicit registration. In such anonymous use scenarios, server 200 may generate and assign a service user identifier (e.g., random/pseudo-random string of characters, numeric identifier, etc.) to the new user for use is accessing/obtaining PAMR instruction and reminder services. If the user does not desire to receive externally communicated (e.g., email, text message, Twitter, etc.) instruction reminders or electronic calendar event invitations, it is possible for the user to be assigned a PAMR instruction service identifier that does not include or provide any personally identifying information associated with the user. Such a system-generated PAMR instruction service identifier may be communicated to mobile device 100 and stored, for example, in a cookie on their mobile device. As long as the user continues to scan and access the associated PAMR instruction service(s) using that same mobile device (i.e., the mobile device where the cookie resides), the user may access and obtain at least some of the associated PAMR instruction services. Once again, this anonymous user access technique may be applied to all embodiments of the PAMR instruction and reminder service disclosed herein. Such embodiments are advantageous in that they allow user who do not want to provide/share any personal information to access the scan-triggered PAMR instruction services disclosed herein. In the various exemplary embodiments disclosed herein, a user could register via a scan-based or other user provisioning interface (not shown) prior to accessing the associated PAMR instruction service(s).

Continuing with step 1, current local date/time information may also be communicated to server 200, or server 200 may consult an alternate time source to obtain current date/time information. In one embodiment, the received PAMR_ID information is used to access the associated instruction set or template, and the user identifier information is used to access the previously created user-specific binding record to obtain the user's PAMR service information. Module 208 examines the user's service binding information and identifies instruction steps/reminders for which the user has not yet signaled compliance (step 2). In step 3, server 200 queries the user via mobile device 100 to determine if the user is, by way of the associated scan of code 418, attempting to signal compliance for a PAMR instruction step/reminder. In step 4, the user, via mobile device 100, responds with information that enables server 200 to determine which PAMR instruction step/reminder is associated with the compliance signal. In step 5, server 200 updates the user's PAMR service binding record to include the compliance signal information. In step 6, server 200 communicates a message to the user via mobile device 100, which acknowledges receipt of the compliance signal. In one embodiment, a compliance incentive reward may be granted to the user via mobile device 100. Step 7 is intended to illustrate the case where the user fails to comply or signal compliance with a PAMR instruction step/reminder. In this case, module 208 is adapted to utilize designated compliance guardian contact information that has been previously provisioned by or on behalf of the user, and to communicate non-compliance alert notification messages to the user's designated compliance guardian 101. Exemplary compliance guardian contact address information 510 is shown in Table 1. In one embodiment, each provisioned instruction step may include a compliance guardian notification indicator or trigger, which is used by module 208 to determine whether non-compliance of an instruction step should trigger a notification to be sent to the user's designated compliance guardian. In one embodiment, module 208 is adapted to communicate a compliance notification alert message to a user's designated compliance in advance of the compliance deadline for an associated instruction step, so as to pre-emptively notify the compliance guardian that an instruction step, while not yet overdue, is nearing a compliance deadline.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth herein.

What is claimed is:

1. A system for providing scan-triggered product-specific instruction and reminder services, the system comprising:
a computing platform including at least one processor:
a server application module executable by or embodied within the at least one processor and configured to:
receive a request for product associated maintenance and reminder (PAMR) service from a scan-enabled client module, wherein the request includes a PAMR instruction set identifier obtained from the scanning of a scanable PAMR service code by a user;
determine a reference time associated with the request for the PAMR instruction service;
use the PAMR instruction set identifier to access an associated product-specific instruction set that contains PAMR instruction steps with relative temporal offsets;
use the reference time to resolve the relative temporal offsets included in the product-specific instruction set so as to obtain resolved temporal scheduling values for the product-specific instruction steps; and
communicate the PAMR instruction steps associated with the resolved temporal scheduling values to the user.

2. The system of claim 1 wherein the PAMR service code includes an encoded network address that is used to route the request to the server application module.

3. The system of claim 1 wherein the server application module is configured to determine the reference time based on information provided by the user.

4. The system of claim 1 wherein the server application module is configured to determine the reference time based on a time of receipt of the request.

5. The system of claim 1 wherein the resolved temporal scheduling values include one of: an amount of time to elapse before a PAMR instruction step is to be performed and a time at which a PAMR instruction step is to be performed.

6. The system of claim 1 wherein the server application module is configured to generate and transmit electronic calendar reminder event invitations associated with the PAMR instruction steps and the resolved temporal scheduling values.

7. The system of claim 1 wherein the server application module is configured to monitor the passage of time and generate and transmit instruction step reminders associated with the resolved PAMR instruction step temporal values.

8. The system of claim 1 wherein the server application module is configured to generate and store a service binding record associated with the user that includes the reference time.

9. The system of claim 1 wherein the server application module is configured to receive and store a compliance signal associated with at least one of the PAMR instruction steps.

10. The system of claim 9 wherein the compliance signal comprises the PAMR instruction service identifier resulting from a scan of the PAMR instruction and reminder service code by the user.

11. The system of claim 9 wherein the server application module is configured to, in response to receiving the compliance signal, grant a compliance incentive reward to the user.

12. The system of claim 9 wherein the server application module is configured to, in response to failing to receive the compliance signal, generate and transmit a non-compliance alert message.

13. The system of claim 1 whereby server application is adapted to grant the user a just in time (JIT) reward.

14. A method for providing scan-triggered product-specific instruction and reminder services, the method comprising:
in a computing platform including at least one processor that executes a server application module:
receiving a request for product associated maintenance and reminder (PAMR) instruction service from a scan-enabled client module, wherein the request includes a PAMR instruction set identifier obtained from the scanning of a scanable PAMR instruction and reminder service code by a user;
determining a reference time associated with the request for the PAMR instruction service;
using the PAMR instruction set identifier to access an associated product-specific instruction set that contains PAMR instruction steps with relative temporal offsets;
using the reference time to resolve the relative temporal offsets included in the PAMR instruction set so as to obtain resolved temporal scheduling values for the PAMR instruction steps; and
communicating the PAMR instruction steps associated with the resolved temporal scheduling values to the user.

15. The method of claim 14 wherein the PAMR service code includes an encoded network address that is used to route the request to the server application module.

16. The method of claim 14 wherein the server application module is configured to determine the reference time based on information provided by the user.

17. The method of claim 14 wherein determining the reference time includes determining the reference time based on a time of receipt of the request.

18. The method of claim 14 wherein the resolved temporal scheduling values include one of: an amount of time to elapse before a PAMR instruction step is to be performed and a time at which a PAMR instruction step is to be performed.

19. The method of claim 14 including generating and transmitting electronic calendar reminder event invitations associated with the PAMR instruction steps and the resolved temporal scheduling values.

20. The method of claim 14 including monitoring the passage of time and generating and transmitting instruction step reminders associated with the resolved PAMR instruction step temporal values.

21. The method of claim 14 including generating and storing a service binding record associated with the user that includes the reference time.

22. The method of claim 14 including receiving and storing a compliance signal associated with at least one of the PAMR instruction steps.

23. The method of claim of claim 22 wherein receiving the compliance signal comprises receiving the PAMR instruction service identifier resulting from a scan of the PAMR instruction and reminder service code by the user.

24. The method of claim 22 including, in response to receiving the compliance signal, granting a compliance incentive reward to the user.

25. The method of claim 22 including, in response to failing to receive the compliance signal, generating and transmitting a non-compliance alert message.

26. The method of claim 1 including granting the user a just in time (JIT) reward.

27. A non-transitory computer readable medium having stored thereon executable instructions that when executed by the processor of a computer control the computer to perform steps comprising:
receiving a request for product associated maintenance and reminder (PAMR) instruction service from a scan-enabled client module, wherein the request includes a PAMR instruction set identifier obtained from the scanning of a scanable PAMR instruction and reminder service code by a user;
determining a reference time associated with the request for the PAMR instruction service;
use the PAMR instruction set identifier to access an associated PAMR instruction set that contains PAMR instruction steps with relative temporal offsets;
using the reference time to resolve the relative temporal offsets included in the PAMR instruction set so as to obtain resolved temporal scheduling values for the PAMR instruction steps; and
communicating the PAMR instruction steps associated with the resolved temporal scheduling values to the user.
